(19) United States
(12) Patent Application Publication
(10) Pub. No.: US 2013/0147600 A1
(43) Pub. Date: Jun. 13, 2013

(54) Access Authorization via Location-Aware Authorization Device

(71) Applicant: James Scott Murray, Glendale Heights, IL (US)

(72) Inventor: James Scott Murray, Glendale Heights, IL (US)

(73) Assignee: THE CHAMBERLAIN GROUP, INC., Elmhurst, IL (US)

(21) Appl. No.: 13/315,810

(22) Filed: Dec. 9, 2011

(51) Int. Cl. G06F 7/04

(52) U.S. Cl. 340/5.71

(57) ABSTRACT

An apparatus and method are provided to allow a user to authorize control of a remote device using a location-aware control device. The location-aware control device compares its location to a target position. When within a user-defined proximity of the target position, the control device offers a user the ability to communicate with a remote device. The remote device may be a movable barrier operator or a web server in communication with a movable barrier operator.

### TECHNICAL FIELD

This generally relates to methods and devices for providing authorization from a location-aware device. More specifically, it relates to actuating movable barriers from a location-aware device.

### BACKGROUND

Movable barrier operators are used to actuate various types of movable barriers. For example, garage door operators are used to move garage doors, and gate operators are used to open and close gates. Such barrier movement operators may include a wall control unit, which sends signals to a head unit thereby causing the head unit to open and close the barrier. In addition, these operators often include a receiver unit to receive wireless transmissions from a hand-held code transmitter or from a keypad transmitter, which may be affixed to the outside of the area closed by the barrier or other structure. However, use of keypad transmitters requires a user to be within the local vicinity of the movable barrier operator. Similarly, use of hand-held code transmitters requires a user to be within a limited transmission range of the movable barrier operator. For example, a user seeking to open a garage door using a transmitter cannot do so unless the user is close enough such that the transmitter can communicate with the movable barrier operator's receiver.

Devices such as mobile phones, personal data assistants, media players, and mobile computing devices such as laptops and tablets can be configured to allow users to accomplish multiple tasks using a single device. For example, a cellular phone may be programmed to allow users to send and receive telephone calls, emails, and data messages (including Short Message Service (SMS) and Multimedia Messaging Service (MMS)), play media content, and access the Internet. Internet-enabled mobile devices also allow users to communicate with other Internet-enabled devices.

While multi-functional mobile devices advantageously reduce the number of devices a user needs, operation of such devices can become cumbersome. Unlike standard hand-held transmitters (such as garage door openers) that may have a single button dedicated to a specific function, multi-functional mobile devices often lack such a feature. Thus, a user may need to perform many steps to execute a desired function on the mobile device. For example, on a smart phone, a user may have to scroll through a list of programs in order to find and select the desired program. This can be particularly disadvantageous when, for example, the user is operating a vehicle.

### SUMMARY

Generally speaking, an apparatus, computer readable medium, and method are provided to allow a user to authorize control of a remote device using a location-aware control device. A user possessing the location-aware control device is able to send commands or other information to a remote device. For example, a control device can offer a user the option to instruct a movable barrier operator to open a garage door when the user is within a defined proximity to the garage.

The control device is location-aware in that it is capable of determining its position using at least in part information received at a receiver. The control device compares its position to that of a user-defined target position to determine whether the control device is within a user-defined proximity to the target position. When within the user-defined proximity, the control device offers a user the ability to communicate with a remote device. The remote device may be a movable barrier operator. Alternatively, the remote device may be a web server. The web server may be in communication with another remote device, such as a movable barrier operator. Thus, the user may choose to instruct a web server to send a command to a movable barrier operator.

The apparatus and method described herein provide several advantages over previous approaches. For example, a user does not need to be located within a limited transmission range to control a remote device. Rather, the user can control the remote device any time the user is within a specified target range, which can be altered as desired by the user.

Another example advantage of the apparatus, computer readable medium, and method described herein is the user can be automatically presented with a prompt including an authorization request in response to the user's being within the target range. The prompt can also be automatically removed in response to the user's no longer being within the target range. This eliminates the need for the user to manually open and close an authorization program on the control device, thereby allowing the user to maintain focus on other activities such as driving.

### BRIEF DESCRIPTION OF THE DRAWINGS

The above needs are at least partially met through provision of the access authorization via location-aware authorization device described in the following detailed description, particularly when studied in conjunction with the drawings, wherein:

FIG. 1 comprises a perspective view of an inside of a garage with a movable barrier and operator as configured in accordance with an embodiment of the invention;

FIG. 2 comprises a schematic block diagram of an entry control system as configured in accordance with various embodiments of the invention;

FIG. 3 comprises a schematic block diagram of a control device as configured in accordance with an embodiment of the invention;

FIGS. 4a and 4b comprise schematic views of a control device and remote device as configured in accordance with various embodiments of the invention;

FIGS. 5a-5c comprise schematic views of a control device as configured in accordance with various embodiments of the invention;

FIGS. 6a-6c comprise schematic diagrams of a target ranges as configured in accordance with various embodiments of the invention;

FIG. 7 comprises a schematic block diagram illustrating a method of using a control device as configured in accordance with an embodiment of the invention.

FIG. 8 comprises another schematic block diagram illustrating a method of using a control device as configured in accordance with an embodiment of the invention.

FIG. 9 comprises a schematic block diagram illustrating a method of controlling operation of a movable barrier operator as configured in accordance with an embodiment of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a location-aware control device determines whether it is within a defined proximity of a predetermined target position. In response to determining that it is within the defined proximity, the control device alerts a user and offers the user the option to communicate with a remote device. In one approach, the communication with the remote device includes sending a command to a movable barrier operator. In another approach, the communication with the remote device includes sending a command to a web server, which then sends a command to a movable barrier operator.

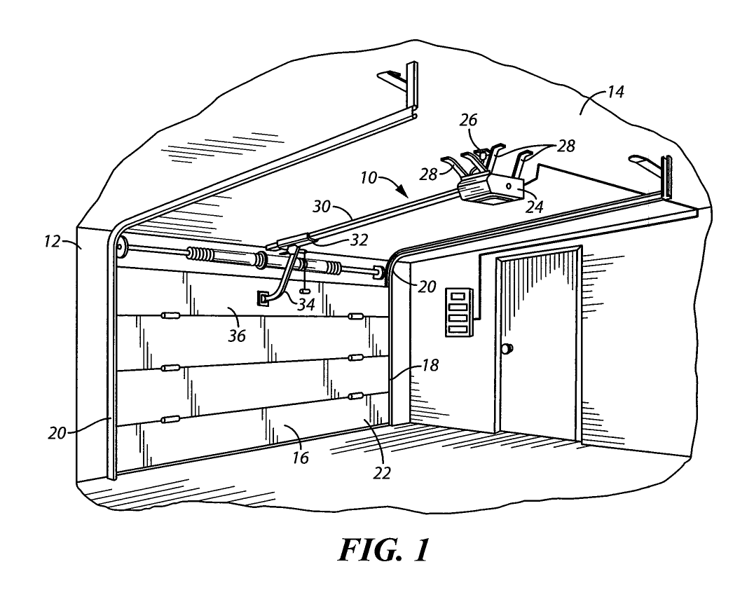

Referring now to the drawings, and in particular to FIG. 1, a movable barrier operator 10 is configured to control movement of the movable barrier 16 between a first position and a second position. The movable barrier operator 10, as illustrated, is within a garage 12. By one approach, it is mounted to a ceiling 14 of the garage 12 for movement of a movable barrier 16. In one illustrative example, the movable barrier 16 is a multipanel garage door having a plurality of rollers 18 that ride within a pair of tracks 20 positioned adjacent to and on opposite sides of a garage opening 22.

In the illustrative example of FIG. 1, the movable barrier operator 10 also includes a head unit 24 for providing motion to the movable barrier 16 via a rail assembly 30. The head unit 24, which includes an electric motor, is powered from a mains voltage outlet 26 and is supported from the joists of the ceiling by support members 28. Alternatively, the head unit 24 may be powered by a battery. The rail assembly 30 includes a trolley 32 for releasable connection of the head unit 24 to the movable barrier 16 via an arm 34. The arm 34 is connected to an upper portion 36 of the movable barrier 16 for opening and closing it. The trolley 32, connected to a drive chain, is driven thereby. By one approach, the chain is driven by a sprocket in the head unit 24. In such a configuration, the sprocket acts as a power takeoff for an electric motor located in the head unit 24.

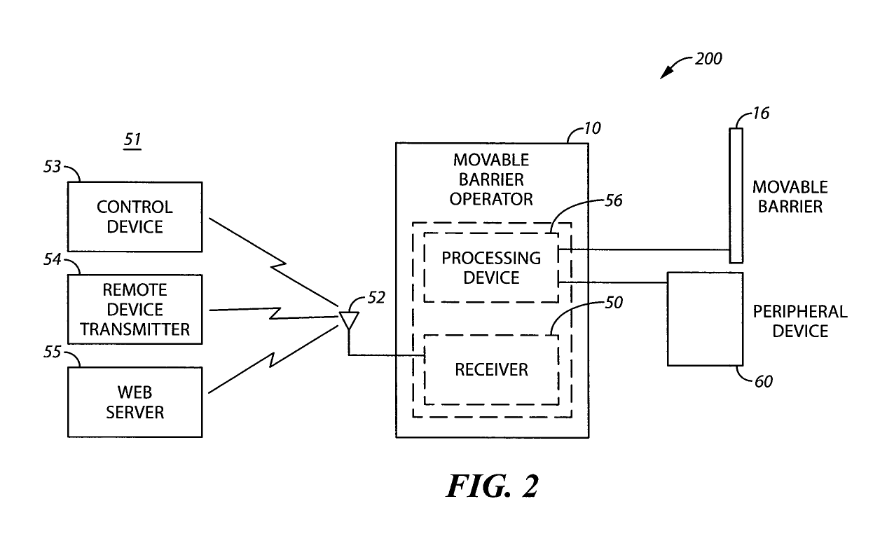

As illustrated in FIG. 2, the movable barrier operator 10 may include a receiver 50 for receiving transmissions from one or more external sources 51. For example, the movable barrier operator 10 may include a receiver 50 for receiving transmissions from one or more control devices 53, as discussed below. In addition, the movable barrier operator 10 also may receive transmissions from one or more remote device transmitters 54, such as wireless garage door openers and keypads, and wired (often wall-mounted) garage door openers and keypads. In addition, the movable barrier operator 10 also may include a receiver 50 for receiving transmissions from one or more web servers 55. Thus, through the receiver 50, the movable barrier operator 10 is capable of receiving communications from any internet-enabled device via a web server 55.

In one approach, the movable barrier operator 10 may include several receivers 50 for receiving different signals. For example, the movable barrier operator 10 may include a receiver 50 configured to receive transmission signals from a control device 53 described further below, a receiver 50 configured to receive transmission signals from a remote device transmitter 54, and a receiver 50 configured to receive transmission signals from a web server 55. In another approach, a single receiver 50 may be configured to receive a variety of different signals from a control device 53, a remote device transmitter 54, and a web server 55.

Communications with the external sources 51 may be wired or wireless. The receiver 50 may wirelessly communicate with the external sources 51 via at least one antenna 52 associated with the receiver 50. Wireless transmissions may be in the form of any wireless communication technology, including cellular communications (such as cellular data networks, text, and short message services), radio waves and other radio communications, wireless local area networks (such as Wi-Fi or WiMax networks), personal area networks (such as a Bluetooth, IrDA, or ZigBee), and other internet communications. The receiver 50 may also be capable of receiving commands via a wired connection, such as through electrical transmission cables, coaxial cables, Ethernet cables, fiber optic communication cables, or other communication cables. Additional forms of known wired and wireless communication may also be utilized.

The movable barrier operator also includes a processing device 56. The processing device 56 is in operative communication with the receiver 50 and configured to interpret signals from the receiver 50. As illustrated in FIG. 2, the processing device 56 and the receiver 50 may comprise physically separate elements or may be integrated into a single unit separate from or combined with the movable barrier operator 10. Each of these arrangements is known in the art and need no further explanation herein.

The processing device 56 may further be configured to provide commands to control aspects of the movable barrier operator 10. Thus, for example, when the movable barrier operator 10 is so instructed by the processing device 56, the operator 10 activates and moves the movable barrier 16. For example, in the illustrative example of FIG. 1, the trolley 32 moves along the rail assembly 30 to thereby move the movable barrier 16 up or down via arm 34.

In addition to controlling movement of the movable barrier 16, the processing device 56 may be configured to provide commands to control one or more peripheral devices 60. Such peripheral devices may include operator lights, external lights, fans, air compressors, security cameras, motion sensors, and alarm systems to name but a few examples. Additional peripheral devices common to households and garages may also be controlled by the movable barrier operator 10.

Those skilled in the art will recognize and appreciate that such a processing device 56 can comprise a fixed-purpose hard-wired platform, which could be as simple as an analog threshold circuit, or can comprise a partially or wholly programmable platform. All of these architectural options are well known and understood in the art and require no further description here.

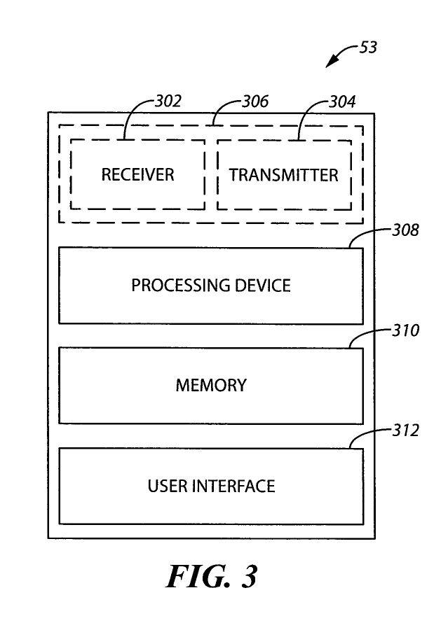

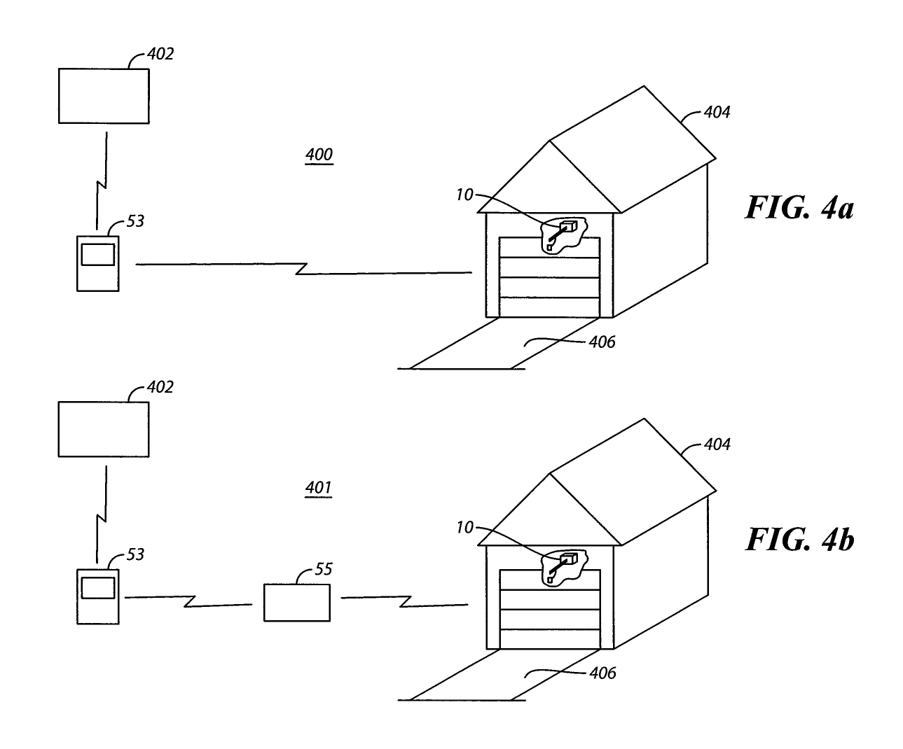

Turning now to FIG. 3, the control device 53 includes a receiver 302 configured to receive positioning information. In one approach, as shown in FIGS. 4a and 4b, the receiver can receive positioning information from a positioning system 402. In one approach, the positioning system 402 is a Global Positioning System. The positioning information may also be received from other systems for providing positioning information, such as systems using Wi-Fi access points, television signals, cellular grids, or Uniform Resource Locators (URLs). The positioning information includes real-time information representative of the control device's current geographic location. The positioning information may also include information such as the control device's previous geographic locations, direction of travel, and speed of travel.

The receiver 302 of FIG. 3 may also be configured to receive various other transmissions such as cellular signals comprising voice and/or data packets, internet transmissions, and other communication protocols.

The control device 53 may also include a memory device 310 capable of storing information. In this way, the control device is able to store received information such as positioning information received at the receiver 302. The memory device 310 of the control device 53 may also store information input by a user.

The control device 53 also includes a processing device 308. The processing device 308 is configured to determine a control device position using at least in part the information from the receiver. The processing device 308 is also configured to compare the control device position to a target position 404 (an example of which is shown in FIGS. 4a and 4b) to determine a geographical relationship between the control device 53 and the target position 404. In one approach, the target position 404 includes a geographic location of a target remote device. In one example, the target remote device is a movable barrier operator 10, and the target position 404 is the geographic location of the movable barrier operator 10. The processing device 308 may further be configured to, in response to determining that the control device 53 is within a target range 600, provide a prompt for a user input. The target position 404 and target range 600 are further discussed below.

The control device 53 may also include a user interface 312. The user interface 312 is configured to convey information to a user. Information may be conveyed visually or audibly. Audible information may include a chime or other audio alert. Visual information can be conveyed to a user, for example, through the illumination of one or more light-emitting diodes. In another approach, visual information is conveyed to a user through a display screen such as a liquid crystal display screen, a light-emitting diode backlit liquid crystal display screen, or other screen capable of conveying information.

The user interface 312 is also configured to receive a user input. In one approach, user input is provided to the control device 53 through a dedicated user input interface. A dedicated user input interface can be separate and apart from the interface used to convey information to the user. Such a dedicated input interface may include a single button, a keypad, or a touch-sensitive surface responsive to a user's touch. In another approach, the user input is provided to the control device 53 through an integrated user input interface. An integrated user input interface may be, for example, in the form of a touch-sensitive display screen. For example, the touch-sensitive display screen may display a virtual button that allows a user to provide an input. In this manner, the same interface that conveys information to a user can also receive a user input.

The control device 53 also includes a transmitter 304. As illustrated in FIG. 3, the transmitter 304 and the receiver 302 may comprise physically separate elements, or may be integrated into a single transceiver 306.

The transmitter 304 is capable of transmitting information from the control device 53 to a remote device. The remote device may be an intermediate remote device or a target remote device. In one example, the transmitter 304 is configured to transmit a command to effect a function of a movable barrier operator 10 in response to the user interface's receiving a user input. Examples of commands sent by the transmitter 304 may include “operate door,” “open,” “close,” “turn on,” “turn off,” “lock,” and “unlock.” The transmitter 304 may also be configured to transmit positioning information identifying the position of the control device 53, identification information identifying the target remote device, and authentication information authenticating the control device 53.

As previously described, the transmitter 304 may be configured to communicate with various remote devices, including intermediate and target remote devices. In one approach 400, as shown in FIG. 4a, the transmitter 304 is configured to transmit a command to a target remote device, such as a movable barrier operator 10. This may be done using any of the wireless communication forms previously discussed (such as radio waves or Bluetooth communications). In another approach 401, as shown in FIG. 4b, the transmitter 304 is configured to transmit a command to an intermediate remote device, such as a web server 55. The web server 55 may be configured to, in response to receiving the command, transmit the command to a target remote device, such as a movable barrier operator 10, to effect a function of the target remote device. For example, a control device 53 can be configured to send an “open” command to a movable barrier operator 10 via the web server 55. Advantageously, through communication with a web server 55, the control device 53 is capable of communicating with a target remote device such as a movable barrier operator 10 from virtually anywhere in the world.

The transmitter 304 may be capable of transmitting the command using various known communication technologies, including cellular communications (such as cellular voice networks, data networks, text, and short message services), radio waves and other radio communications, wireless local area networks (such as Wi-Fi or WiMax networks), personal area networks (such as a Bluetooth, IrDA, or ZigBee), and other internet communications. The transmission of information by the transmitter 304 may be an encoded transmission encoded through any known encoding methods. See for example U.S. Pat. No. 6,154,544, U.S. Pat. No. 7,071,850, U.S. Pat. Pub. No. 2007/0005806, and U.S. Pat. Pub. No. 2007/0058811, each of which is incorporated by reference as if wholly rewritten herein.

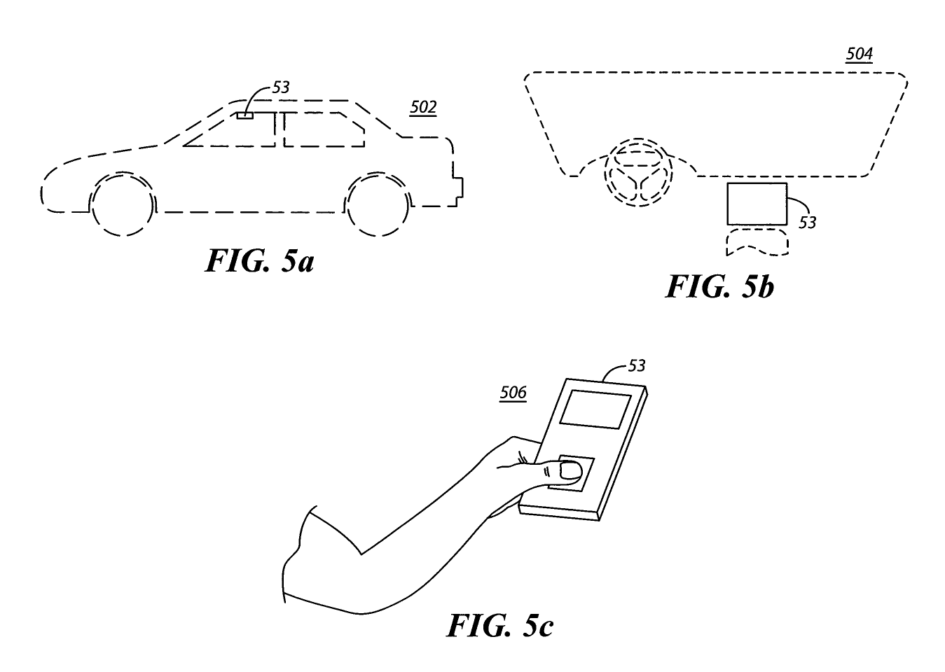

Turning now to FIGS. 5a and 5b, in one approach, the control device 53 is an in-dash device in an automobile. The control device 53 may be mounted, for example, in an overhead console 502 or in a main dashboard console 504. In another approach 506, shown in FIG. 5c, the control device 53 is a hand-held device. The control device 53 may also be a dedicated, single-use device configured to provide location-based authorization commands to remote devices. In another approach, the control device 53 is capable of providing one or more functions in addition to providing location-based authorization commands to remote devices. Examples of multi-use devices include cellular phones, personal data assistants, media players, tablets, portable computing devices, and the like. For example, a multi-use device may be configured to provide cellular voice communication capabilities, as well as be configured to send location-based authorization commands to remote devices.

As previously discussed, the processing device 308 is configured to compare the control device position to a target position 404 to determine a geographical relationship between the control device 53 and the target position 404. A target position 404 can be the geographic location that is associated with a target remote device. For example, the target position 404 may be represented by GPS coordinates of a movable barrier 16, a movable barrier operator 10, a driveway location 406, or any other location generally associated with a target remote device sought to be controlled. Alternatively, the target position 404 may be any distance away from the target remote device.

Target positions 404 can be stored in the memory 310 of the control device 53. The memory 310 may store multiple target positions. The multiple target positions may be associated with multiple target remote devices. For example, a user may define a target position 404 at each of a first house, a second house, and an office building. The multiple target positions 404 may also be associated with a single target remote device.

In one approach, the geographic location of the target position 404 is acquired by the control device 53 via the receiver 302. For example, a user may wish to identify a movable barrier operator 10 as the target position 404. To set the target position 404, the control device 53 is positioned near the movable barrier operator 10. The control device 53 receives information at the receiver 302 while located near the movable barrier operator 10. Using at least in part this received information, the control device 53 is able to determine the geographic position of the control device. The user can instruct the control device 53 to store the geographic information as the target position 404 in the memory 310. Alternatively, the control device 53 can automatically store the geographic information in the memory 310.

In another approach, the control device 53 can receive geographic location information from a web server, computer network, or other external source. For example, a user can input a postal address of a house or business located near the target position 404. The control device 53 can then retrieve the geographic location of the desired target position 404 from the external source. In another example, the user may input a postal address or geographic location into a separate device, such as a computer. The user-input information may then be stored on a web server and be subsequently retrieved by the control device 53. This user-input information may then be stored as the target position 404 in the memory 310 of the control device 53.

In another approach, the user can manually input the target position 404 into the control device 53. For example, if the user knows the GPS coordinates of the desired target position 404, the user can input this geographic location information via the user interface 312 of the control device 53. This manually-input geographic location information may then be stored in the memory 310 of the control device 53.

Through any of the previously described approaches, the user can teach the control device 53 the desired target position 404.

As previously stated, the processing device 308 of the control device 53 is configured to compare the control device position to a target position 404 to determine whether the control device 53 is within a target range 600. The target range 600 will now be described in further detail.

The target range 600 is a defined geographic relationship. In one approach, the target range 600 is a user-defined zone or location. In another approach, the target range 600 is a predefined zone or location (such as one or more selectable default ranges) defined by a relationship with the target position 404 and selectable by a user.

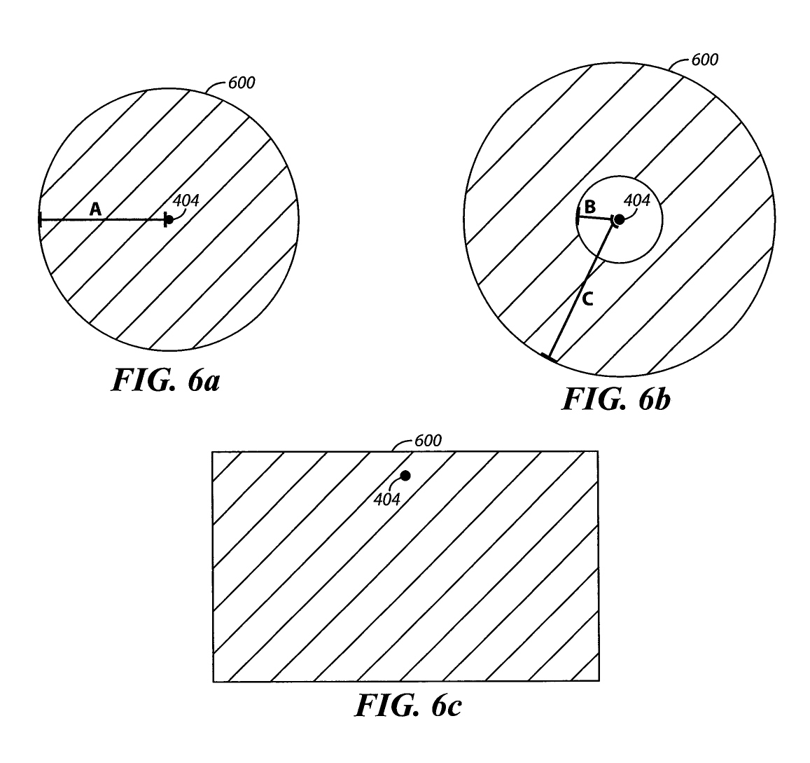

In one approach, as shown in FIG. 6a, the target range 600 may consist of a proximity defined as a radius A about a target position 404. For example, the target range 600 may be defined as a radius of 500 feet about a target position 404 that has been associated with a movable barrier operator 10. In another approach, shown in FIG. 6b, the target range 600 may consist of an annular range defined by radius B and radius C about a target position 404. In another approach, shown in FIG. 6c, the target range 600 may be non-circular. As further shown in FIG. 6c, the target range 600 need not be centered about or even encompass the target position 404.

For instance, where the target position 404 is a garage door operator, the target range 600 can be configured to match certain streets that approach the target position 404 such that the prompt for a user input is provided in response to the control device's determining that it has crossed into a target range 600 by approaching along a street toward the garage door operator. The prompt allows a user to transmit a command to open the garage door such that the garage door is open by the time the user reaches the target position 404 such that the user need not wait for the garage to open upon arrival.

In yet another approach, the target range 600 can be set to a “universal” mode such that all geographic locations are encompassed within the target range 600. Alternatively, the target range 600 can be disabled. The target range 600 may be modified by the user.

In one approach, the target range 600 is stored in the memory 310 of the control device 53. In another approach, the control device 53 accesses the target range 600 from a separate memory location such as a remote memory or cloud storage device.

The control device 53 may be configured to access multiple target ranges. The multiple target ranges may be associated with multiple target remote devices. For example, a user may define a target range 600 for each of a first house, a second house, and an office building. Additionally, the multiple target ranges may be associated with a single target remote device.

The control device 53 may further be able to access identification information to identify the target remote device. The control device 53 may further be able to access authentication information for authenticating the control device 53 to the target remote device. Additionally, the memory 310 can store authentication information for authenticating the control device 53 to the target remote device. The identification information and/or the authentication information may be stored in the memory 310 of the control device 53. In another approach, the control device 53 accesses the identification information and/or the authentication information from a separate memory location such as a remote memory or cloud storage device.

When the processing device 308 determines that the control device 53 is within the target range 600, the processing device 308 is configured to provide a prompt for user input. In one approach, the processing device 308 can prompt a user for an input via the user interface 312. In one example, the prompt includes an authorization request. In this example, the prompt may request authorization to transmit a command or other information to one or more remote devices. The prompt may be in the form of a message provided visually or audibly by the user interface 312. A user of the control device 53 may respond to a prompt by providing an input via the user interface 312. This can be done through any manner provided by the user interface 312 discussed above, including pressing a button or tapping a location on a touch-sensitive screen. Additionally, the user can provide input in the form of an audio command.

In one approach, the prompt may be provided visually through a program such as an authorization request program running on the control device 53. In this approach, to provide the prompt to the user of the control device 53, the processing device 308 may transform the control device 53 from a first state to a second state. For example, the processing device 308 may transform the program from an inactive state to an active state, from a background state to a foreground state, or from a closed state to an open state. The second state allows the user to interact with the program. In this approach, the user is presented with an authorization request when the program is in the second state. In one example, the authorization request provides the user with the option to control a target remote device, such as a movable barrier operator 10. In another example, the authorization request may provide the user with the option to control multiple target remote devices. In another example, the authorization request may provide the user with the option to send multiple commands to a single target remote device. In this example, the authorization request may provide the user with the option to command a movable barrier operator 10 to control a movable barrier 16 and a peripheral device 60. When presented with the authorization request, the user may choose to control all of the remote devices, a selection of the remote devices, or none of the remote devices.

To control the one or more remote devices, the user inputs one or more selections. For example, the user may authorize the control device to transmit an “open” command to a movable barrier operator 10 by tapping the appropriate button on a touch-sensitive display screen. The user may also choose to control more than one remote device through a single user input. In one approach, a user may be required to provide authorization information such as an authorization code prior to controlling the remote device.

In one approach, the processing device 308 is configured to remove the prompt for the user input in response to determining that the control device 53 is not within the target range 600. In another approach, the processing device 308 is configured to remove the prompt for the user input after a period of time has elapsed. In yet another approach, the processing device 308 is configured to remove the prompt for the user input in response to receiving the user input.

In another approach, the target range 600 is a defined geographical relationship. As in previous approaches described herein, with reference to FIG. 3, the control device 53 includes a receiver 302 configured to receive information, a processing device 308, a user interface 312 configured to receive user input, and a transmitter 304 configured to effect a function of a movable barrier operator 10 in response to receiving the user input.

In this approach, the processing device 308 is configured to compare the control device position to a target position 404 to determine a geographical relationship between the control device 53 and the target position 404. In one example, the processing device 308 is configured to compare the control device position to the target position 404 to determine the distance between the between the control device 53 and the target position 404. When the processing device 308 determines that the geographical relationship is within the defined geographical relationship, i.e., within the target range 600, the processing device 308 is configured to provide a prompt for a user input.

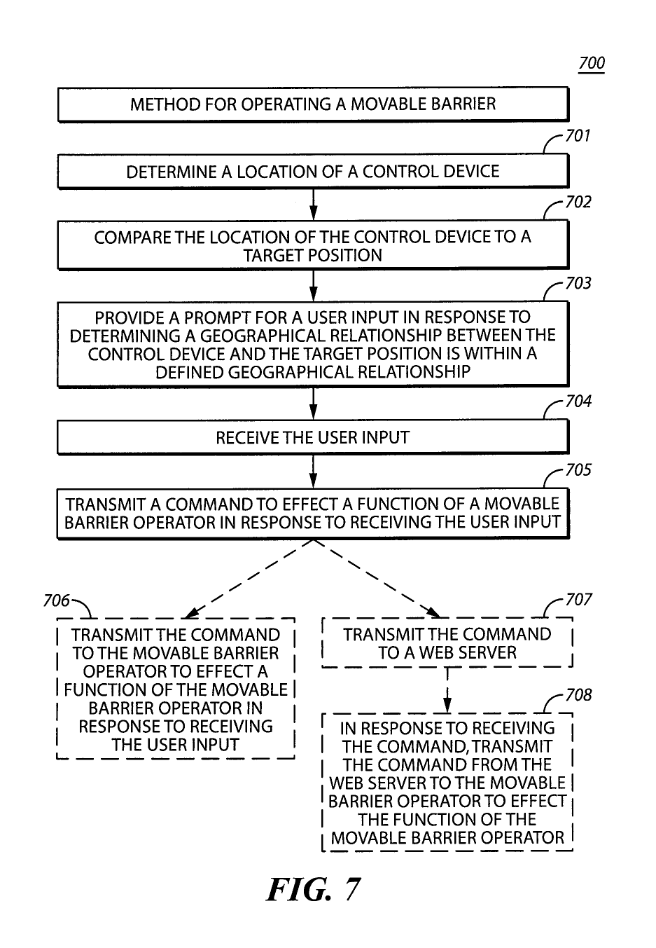

Turning now to FIG. 7, a method 700 for operating a movable barrier, such as barrier 16, includes determining 701 a location of a control device 53. In one approach, determining the location can include receiving positioning information from a positioning system such as a GPS system. The method 700 further includes comparing 702 the location of the control device 53 to a target position 404. The method also includes providing 703 a prompt for a user input in response to determining a geographical relationship between the control device 53 and the target position 404 is within a defined geographical relationship 600. The method further includes receiving 704 the user input and transmitting 705 a command to effect a function of a movable barrier operator 10 in response to receiving the user input. In one approach, the command is transmitted 706 to the movable barrier operator 10. In another approach, the command is transmitted 707 to a web server 55. In this approach, the method 700 further includes, in response to receiving the command, transmitting 708 the command from the web server 55 to the movable barrier operator 10 to effect the function of the movable barrier operator 10.

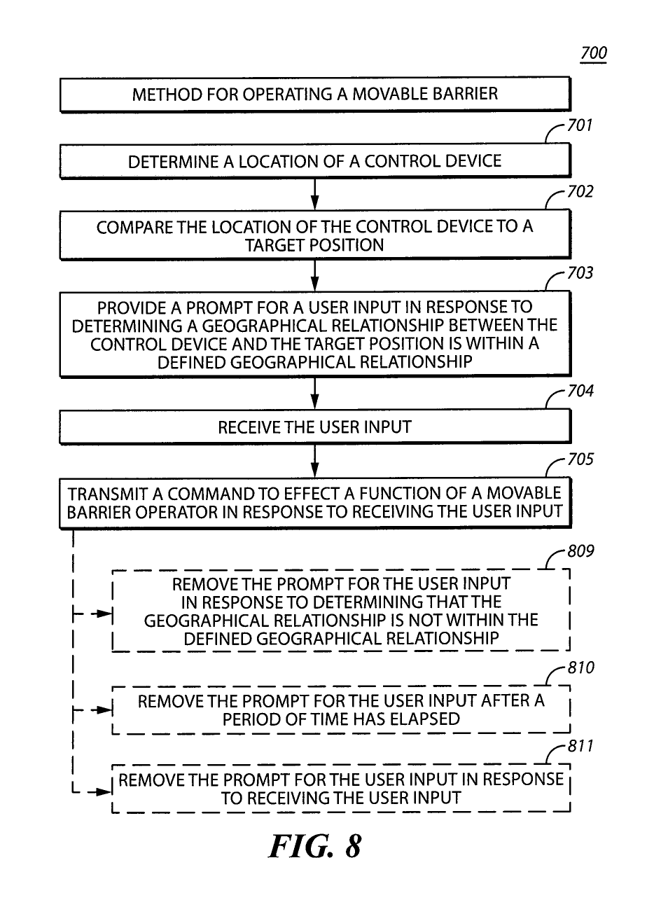

In another approach, shown in FIG. 8, the method 700 includes removing 809 the prompt for the user input in response to determining that the geographical relationship is not within the defined geographical relationship 600. In another approach, the method 700 includes removing 810 the prompt for the user input after a period of time has elapsed. In another approach, the method 700 includes removing 811 the prompt for the user input in response to receiving the user input.

So configured, such a method automatically prompts a user when the user possessing the control device 53 is within a defined geographical relationship with a target position 404. This automatic prompt allows a user to quickly and simply control a remote target device such as a movable barrier operator 10 without the need to manually open and close an authorization program on the control device 53, thereby allowing the user to maintain focus on other activities such as driving. Furthermore, because the user may communicate with a target remote device via a web server 55, the user does not need to be located within a limited transmission range to control the target remote device.

With reference again to FIG. 3, the above teachings can be performed by a non-transitory computer-readable medium 310 encoded with executable instructions. A non-transitory computer-readable medium may comprise all computer-readable media except for a transitory, propagating signal. The executable instructions comprise instructions that cause a control device 53 to determine a location of the control device 53 and compare the location of the control device 53 to a target position 404. The executable instructions further comprise instructions that cause the control device to provide a prompt for a user input in response to determining a geographical relationship between the control device 53 and the target position 404 is within a defined geographical relationship 600. The executable instructions further comprise instructions that cause the control device to transmit a command to effect a function of a movable barrier operator 10 in response to receiving a user input.

The above teachings can be employed in an example entry control apparatus 200 as described with reference to FIG. 2. The exemplary entry control apparatus 200 includes a movable barrier operator 10 operably connected to a movable barrier 16. The movable barrier operator 10 is configured to control movement of the movable barrier 16. The entry control apparatus 200 includes a receiver 50 operably coupled to the movable barrier operator 10 configured to receive a command to effect a function of the movable barrier operator 10. In one approach, the receiver 50 receives the command from a control device 53. In another approach, the receiver 50 receives the command from a web server 55. The command is transmitted in response to a user input, which is provided in response to determining a geographical relationship between a control device 53 and a target position is within a defined geographical relationship. The entry control apparatus 200 typically includes a processing device 56 operably coupled to the movable barrier operator 10 to effect the function of the movable barrier operator 10.

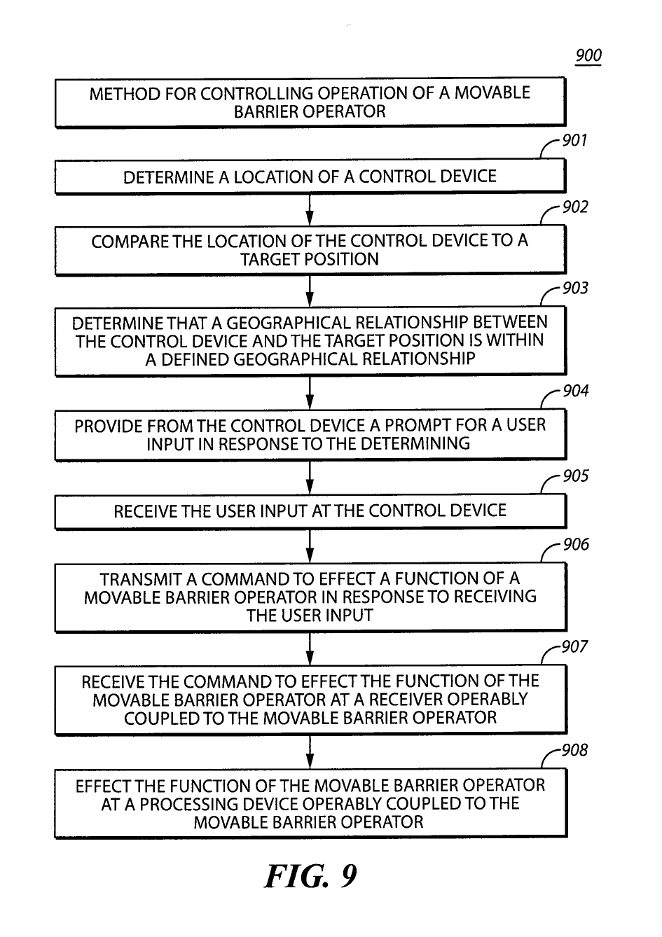

The above teachings can also be employed in an example method 900 for controlling operation of a movable barrier operator, as described with reference to FIG. 9. The exemplary method 900 for controlling operation of a movable barrier operator includes determining 901 a location of a control device 53 and comparing 902 the location of the control device to a target position. The method further includes determining 903 a geographical relationship between the control device 53 and the target position is within a defined geographical relationship. The method further includes providing 904 a prompt from the control device 53 for a user input in response to the determining 903. The method 900 for controlling operation of a movable barrier operator also includes receiving 905 the user input at the control device 53, and transmitting 906 a command to effect a function of a movable barrier operator in response to receiving the user input. The method further includes receiving 907 the command to effect the function of the movable barrier operator at a receiver operably coupled to the movable barrier operator, and effecting 908 the function of the movable barrier operator at a processing device operably coupled to the movable barrier operator.

So configured, such an entry control apparatus 200 and method 900 for controlling operation of a movable barrier operator allow a user to quickly and simply command a movable barrier operator to perform commands, such as opening a garage door, when the user is approaching. Because the control device 53 is location-aware, it is able to automatically prompt the user when the user has entered a predetermined proximity to the garage door.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A control apparatus comprising:
a receiver configured to receive information;
a processing device configured to determine a control apparatus position using at least in part the information from the receiver and to compare the control apparatus position to a target position to determine whether the control apparatus is within a target range, the processing device further configured to provide a prompt for a user input in response to determining that the control device is within the target range;
a user interface configured to receive the user input; and
a transmitter configured to transmit a command to effect a function of a movable barrier operator in response to the user interface's receiving the user input.

2. The control apparatus of claim 1, wherein the target position comprises a geographic location of a remote device.

3. The control apparatus of claim 1, wherein the transmitter is configured to transmit the command to the movable barrier operator.

4. The control apparatus of claim 1, wherein the transmitter is configured to transmit the command to a web server.

5. The control apparatus of claim 4, wherein the web server is configured to, in response to receiving the command, transmit the command to the movable barrier operator to effect the function of the movable barrier operator.

6. The control apparatus of claim 1, wherein the receiver receives positioning information from a positioning system.

7. The control apparatus of claim 1, wherein the processing device is configured to remove the prompt for the user input in response to determining that the control device is not within the target range.

8. The control apparatus of claim 1, wherein the processing device is configured to remove the prompt for the user input after a period of time has elapsed.

9. The control apparatus of claim 1, wherein the control apparatus comprises an in-dash device in an automobile.

10. The control apparatus of claim 1, wherein the control apparatus comprises a hand-held device.

11. A method for operating a movable barrier comprising:
determining a location of a control device;
comparing the location of the control device to a target position;
providing a prompt for a user input in response to determining a geographical relationship between the control device and the target position is within a defined geographical relationship;
receiving the user input; and
transmitting a command to effect a function of a movable barrier operator in response to receiving the user input.

12. The method of claim 11, wherein the target position comprises a geographic location of a remote device.

13. The method of claim 11, wherein the command is transmitted to the movable barrier operator.

14. The method of claim 11, wherein the command is transmitted to a web server.

15. The method of claim 14, further comprising, in response to receiving the command, transmitting the command from the web server to the movable barrier operator to effect the function of the movable barrier operator.

16. The method of claim 11, wherein determining the location of the control device further comprises receiving positioning information from a positioning system.

17. The method of claim 11, further comprising removing the prompt for the user input in response to determining that the geographical relationship is not within the defined geographical relationship.

18. The method of claim 11, further comprising removing the prompt for the user input after a period of time has elapsed.

19. A non-transitory computer-readable medium encoded with executable instructions, the executable instructions comprising instructions that cause a control device to perform operations comprising:
determining a location of the control device;
comparing the location of the control device to a target position;
providing a prompt for a user input in response to determining a geographical relationship between the control device and the target position is within a defined geographical relationship;
receiving the user input; and
transmitting a command to effect a function of a movable barrier operator in response to receiving the user input.

20. An entry control apparatus comprising:
a movable barrier operator operably connected to a movable barrier, the movable barrier operator configured to control movement of the movable barrier;
a receiver operably coupled to the movable barrier operator, the receiver configured to receive a command to effect a function of the movable barrier operator;
a processing device operably coupled to the movable barrier operator, the processing device configured to effect the function of the movable barrier operator;
wherein the command is transmitted in response to a user input provided in response to determining a geographical relationship between a control device and a target position is within a defined geographical relationship.

21. The entry control system of claim 20, wherein the receiver receives the command from the control device.

22. The entry control system of claim 20, wherein the receiver receives the command from a web server.

23. A method for controlling operation of a movable barrier operator, the method comprising:
determining a location of a control device;
comparing the location of the control device to a target position;
determining that a geographical relationship between the control device and the target position is within a defined geographical relationship;
providing from the control device a prompt for a user input in response to the determining;
receiving the user input at the control device;
transmitting a command to effect a function of the movable barrier operator in response to receiving the user input;
receiving the command to effect the function of the movable barrier operator at a receiver operably coupled to the movable barrier operator; and
effecting the function of the movable barrier operator.
